(19) United States
(12) Patent Application Publication
(10) Pub. No.: US 2007/0237385 A1
(43) Pub. Date: Oct. 11, 2007

(54) Defect inspection apparatus

(75) Inventor: Hiroshi Kato, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, Tokyo (JP)

(21) Appl. No.: 11/784,361

(22) Filed: Apr. 6, 2007

(30) Foreign Application Priority Data
Apr. 10, 2006 (JP) P2006-107466

(51) Int. Cl. G06K 9/00

(52) U.S. Cl. 382/149

(57) ABSTRACT

A defect inspection apparatus has a camera that acquires a surface image of an inspection object by scanning in an uniaxial direction, with the output of the camera being passed to an image capture circuit of a control portion. The image capture circuit acquires the image data captured from the camera respectively at a position where an imaging start trigger was received, a capture start pixel position, and a capture end pixel position and thereby creates only the image of the defect area and performs image processing or the like. It is thus possible to quickly perform inspections by quickly extracting necessary information from an inspection object such as a substrate or the like.

### BACKGROUND OF THE INVENTION

1. Field of the Invention

The present invention relates to a defect inspection apparatus used for defect inspection of a substrate.

Priority is claimed on Japanese Patent Application No. 2006-107466, filed Apr. 10, 2006, the content of which is incorporated herein by reference.

2. Description of Related Art

In the manufacturing process of a semiconductor wafer, a liquid-crystal glass substrate, a printed circuit board, and the like, defect inspection is carried out to inspect for defects on the surface of a substrate using a line sensor camera. An image scanning device that scans the image of an imaging object using a line sensor camera is used for a defect inspection apparatus that is employed for such defect inspection (for example, refer to Japanese Unexamined Patent Application No. 2002-77874). In this type of image scanning device, a line sensor camera is constituted to be able to partially mask light using a mask plate. This allows the same line sensor camera to be used for a variety of electronic parts, with the mask plate being used in accordance with the size and shape of the imaging objects. By receiving light only in the range required for the line sensor camera, the image size can be decreased.

Moreover, there is known a defect detection method that involves compressing two-dimensional raw image data obtained from a line sensor camera, performing image processing on the compressed image data to detect positions of defects, and restoring the image of the defect position from the raw image data (for example, refer to Japanese Unexamined Patent Application No. 2002-83303).

### SUMMARY OF THE INVENTION

The present invention is a defect inspection apparatus provided with an imaging device that reads image data as optical image information of an inspection object; an image compression portion that, treating the image data captured by the imaging device as a raw image, compresses the raw image to generate compressed image data; a defect extracting portion that extracts a defect area including a defect of the inspection object from the compressed image data; and an area designating portion that designates the defect area extracted by the defect extracting portion; which performs defect inspection on raw image data of an obtained area that is designated and acquired by the area designating portion.

### BRIEF DESCRIPTION OF THE DRAWINGS

FIG. 1 is a block diagram showing an outline configuration of the defect inspection apparatus according to an embodiment of the present invention.

FIG. 2 is a drawing showing the detailed constitution of the inspection portion of the defect icon apparatus

FIG. 3 is a drawing illustrating a concrete example of a process of obtaining a raw image.

FIG. 4 is a drawing illustrating a concrete example of the process of obtaining only the image of the defection region.

FIG. 5 is a drawing illustrating a concrete example of the process of extracting the edge cut line from the raw image.

FIG. 6 is a drawing illustrating a concrete example of the process of cutting away the image of the defection region from the raw image.

### DETAILED DESCRIPTION OF THE INVENTION

A first embodiment of the present invention shall be described below in detail with reference to the attached drawings.

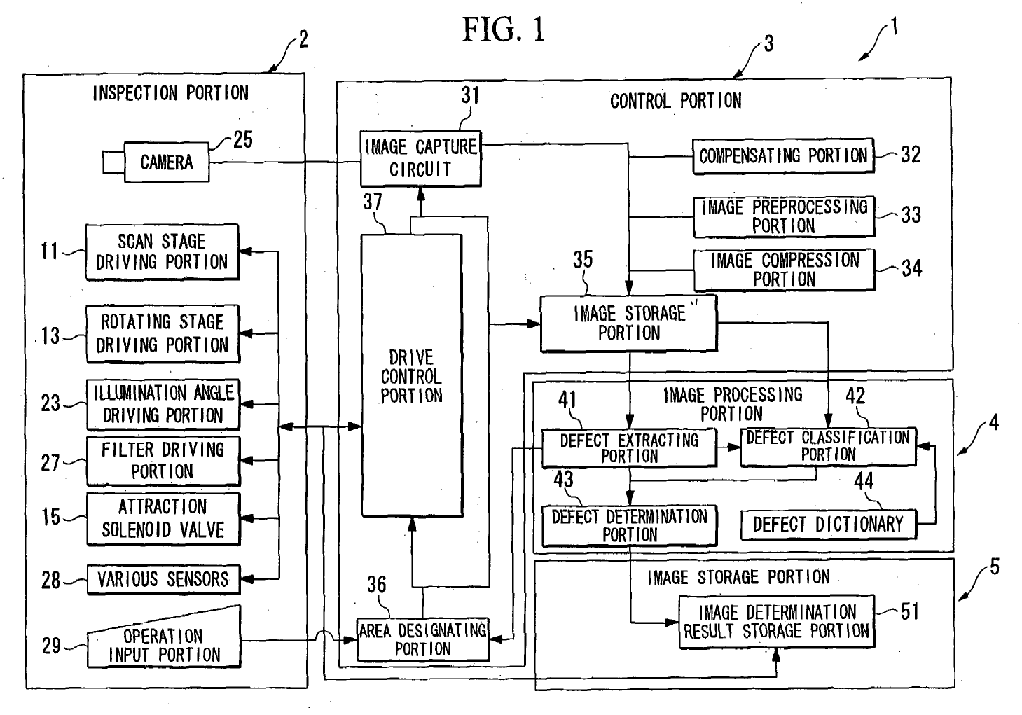

As shown in FIG. 1, a defect inspection apparatus 1 has an inspection portion 2 that obtains an image of a plate-shaped inspection object W such as a semiconductor wafer or glass substrate or the like; a control portion 3 that captures an image of the inspection object W and performs image preprocessing while controlling the inspection portion 2; an image processing portion 4 that receives information from the control portion 3 and performs image processing such as defect extraction and the like; and an image storage portion 5 that stores a defect image that is performed image processing and a determination result or the like.

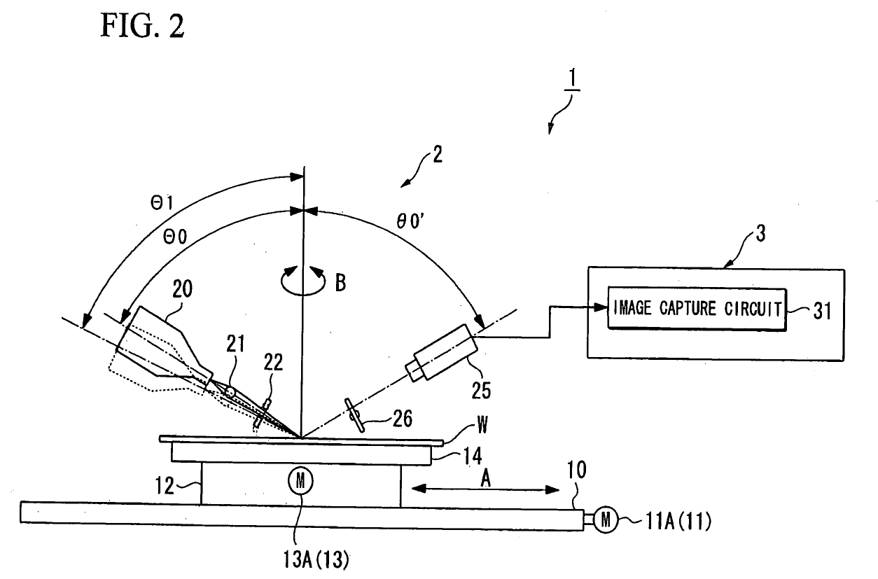

As shown in FIG. 1 and FIG. 2, the inspection portion 2 has a scan stage 10 (holding portion), with the scan stage 10 provided with a scan stage driving portion 11 that includes a motor 11a. The scan stage driving portion 11 is a driving portion that drives a rotating stage 12 (holding portion) mounted on the scan stage 10 in a linear direction shown by an arrow A. The rotating stage 12 freely rotates in a rotative direction shown by an arrow B by a rotating stage driving portion 13 that includes a motor 13A that is mounted therein. The rotating stage driving portion 13 is a driving portion that performs alignment in the direction of rotation of the inspection object W. A table 14 is mounted on the top side of the rotating stage 12. The table 14 is connected to an attraction solenoid valve 15 and so can fix the inspection object W by vacuum attraction.

Above the table 14, an illumination portion 20 is arranged facing the inspection object W. The illumination portion 20 has a light source for illumination and an optical system. In the light source for illumination, a lamp house that is equipped therein with, for example, a halogen lamp, a heat ray absorption filter, and a condenser lens is used. The optical system for illumination uses a condenser lens that converges light rays from the lamp house and a fiber bundle in which an emitting end for performing line illumination is linearly formed. The illumination part 20 illuminates the inspection object W at an incident angle θ0, with a cylindrical lens 21 that converges the luminous flux and a slit 22 being disposed therebetween. The illumination portion 20, the cylindrical lens 21, and the slit 22 are integrally constituted. The angle with respect to the surface of the inspection object W can be freely changed by an illumination angle driving portion 23. For example, it is possible to illuminate the surface of the inspection object W by an incident angle θ1 that is greater than the incident angle θ0.

Moreover, a line sensor camera 25 (imaging device) which acquires optical image information of the inspection object W is disposed above the stage 14 so that reflected light from the illumination portion 20 can be incident thereon. A plurality of imaging elements (sensors) are linearly disposed, in the line sensor camera 25, in a direction intersecting the direction of scanning, so that an image is formed thereon of a linear region of the inspection object W. A filter 26 is disposed between the line sensor camera 25 and the inspection object W. A narrow band filter is used for the filter 26 so that an interference image may be obtained by restricting the wavelength band of the illumination light. A filter driving portion 27 is used to move the narrow band filter in and out of the optical path and perform switching of the type of filter 26.

Various sensors 28 of the inspection portion 2 shown in FIG. 1 are sensors which detect attraction holding of the inspection object W, the tilt angle of the illumination portion 20, etc., to thereby enable correct inspection. An operation input portion 29 receives operations from an operator and carry out various processes described below. The inspection portion 2 having such a constitution is housed in a case of dark box state not shown so as not to be affected by outside illumination. Moreover, in order to prevent particles from adhering to the inspection object W, a downward airflow passes from above the case through an air-cleaning filter.

Next, the control portion 3 has an image capture circuit 31 (image capture portion). Data of one line that is imaged by the line sensor camera 25 is taken into the image capture circuit 31 in synchronization with the movement of the scan stage 10 or in synchronization with the rotation of the rotating stage 12. By performing processing to join together each one-line data perpendicularly (the direction of movement of the stages 10 and 12), the image of the entire inspection object W is converted into a single two-dimensional image (raw image).

A compensating portion 32 is connected to the image capture circuit 31. The compensating portion 32 performs various types of compensation on the data of the raw image. For example, generally the light distribution of the illumination portion 20 is not uniform, with uneven amounts of light existing in the illuminated portions of the inspection object W. Also, the sensitivity of each imaging element of the line sensor camera 25 is not uniform. For this reason, shading is known to occur in the output data of the line sensor camera 25. The compensating portion 32 therefore applies compensation to the raw image data using shading data stored in advance to correct to the original image. Moreover, when various lenses are inserted in the optical path from the illumination portion 20 of the inspection object W to the line sensor camera 25, distortions arise in the output data of the line sensor camera 25 due to irregularities and aberration of the lenses or the like. Such distortion is also corrected to the image to which the original magnification is applied by using distortion data stored in advance in the compensating unit 32.

An image preprocessing portion 33 is connected to the compensating unit 32, so that preprocessing such a as filtering or the like can be performed as required. An image compression portion 34 and an image storage portion 35 are connected to the image preprocessing portion 33.

The image compression portion 34 compresses the raw image data to shrink the image size by an arithmetic operation with adjacent pixels on raw image data that is preprocessed in the image preprocessing portion 33. As an image compression method, it is possible to select one that takes the average of each pixel data in a 2-by-2-pixel region, omits data other than the maximum luminance data of an 8-by-8-pixel region, or conversely omits data other than the minimum luminance data.

The image storage section 35 can store any image and can read these images in addition to the raw image data output from the image preprocessing portion 33 and the image data compressed by the image compression portion 34. Moreover, processing which cuts out the region specified by an area designating portion 36 from the raw image data is carried out. In addition, the image storage portion 35 can output image data to a defect extracting portion 41 or a defect classification portion 42 of the image processing portion 4.

The area designating portion 36, upon receiving an instruction from the operation input portion 29 or receiving instructions from the image processing portion 4, specifies to a drive control portion 37 the region of the image to be acquired from the inspection object W. Moreover, it instructs the image storage portion 35 to extract image data of a predetermined region from raw image data or compressed image data.

The drive control portion 37 controls the control for moving the inspection object W and the various drive portions for the above-mentioned optical system. The filter driving portion 27, the scan stage driving portion 11, an illumination angle driving portion 23, the rotating stage driving portion 13, the attraction solenoid valve 15, and the various sensors 28 are connected to the drive control portion 37. Based on the region specified by the operation input portion 29 and the defect area extracted by the defect extracting portion 41, control with each drive portion and the image capture circuit 31 is performed, and the image data of only the region specified by the area designating portion 36 can be retrieved by the image capture circuit 31.

The image processing portion 4 that is connected to the control portion 3 has the defect extracting portion 41. The defect extracting portion 41 receives image data that is stored in the image storage portion 35, removes the outer shape image of the inspection object, which is a characteristic image of the inspection object W, and the specific pattern image or the like and extracts the defect area using pattern matching or the like. Moreover, the region where the defect was extracted is notified to the area designating portion 36.

The defect classification portion 42 classifies the defect by comparing the image of the defect area extracted in the defect extracting portion 41 and data stored in a defect dictionary 44 and specifies the defect type. For the specified defect, defect information (classification and type of the defect) is created.

A defect determination portion 43 regards the inspection object as being non-defective when a defect is not extracted by the defect extracting portion 41. When a defect is extracted by the defect extracting portion 41, the defect determination portion 43 determines whether or not a defect exists on the inspection object W from the content of the defect information specified by the defect classification portion 42. Moreover, it determines from the content and position of the defect whether or not the inspection object W may be passed downstream in the production line. The data used as the criterion of judgment is registered in advance. The decision result of the defect determination portion 43 passed over to the image storage portion 5.

The image storage portion 5 has an image determination result storage portion 51. The raw image data of the defect area that is extracted by the defect extracting portion 41 and the raw image data of the defect area in the case of imaging with altered imaging conditions, information such as the type and name of a defect that is classified by the defect classification portion 42, and the determination result of the defect determination portion 43 or the like are stored in the image determination result storage portion 51.

Next, the effect of the present embodiment shall be described.

First a plurality of the inspection objects W that are sent from upstream in the production line are loaded and set in carriers not shown manually or by a production line conveying device (hereinbelow referred to as the conveying device). Then, the inspection start is input to the operation input portion 29 shown in FIG. 1 by the conveying device or the like to start operation of the defect inspection apparatus 1.

The conveying device or the like takes out a specified inspection object W from the carrier and accurately places it, with its decentration corrected, on a table 14. When the inspection object W is accurately placed on the table 14, the drive control portion 37 of FIG. 1 turns the attraction solenoid valve 15 ON to attract and fix the inspection object W on the table 14. Then, the drive control portion 37 issues an instruction to the scan stage driving portion 11 to move the scan stage 10 and move the periphery portion of the inspection object W to within the measurement range of a notch detection sensor which is included in the various sensors 28. Moreover, the drive control portion 37 issues an instruction to the rotating stage driving portion 13 to rotate the rotating stage 12. When the notch detection sensor detects a notch on the periphery portion of the inspection object W, that position is registered as a reference. Thereafter, the rotating stage 12 is rotated so that the rotation position of the inspection object W may always be the same.

After determining the rotation position of the notch detection sensor and the rotating stage 12, the drive control portion 37 issues an instruction to the filter driving portion 27 to remove the narrow band filter 26 from the optical path. Moreover, an instruction is sent to the illumination angle drive portion 23 to adjust the illumination angle so that the illumination portion 20 illuminates the inspection object W at, for example, an incident angle θ1. Since the preparation stage is thereby completed with the processing up to this point, the illumination portion 20 illuminates the inspection object W to commence acquisition of the entire image thereof.

Although the illumination portion 20 illuminates the inspection object W, within the light flux emitted from the illumination portion 20, since the unnecessary light flux that diffuses outside the incident angle θ1 is blocked by the slit 22, only light that is incident mostly at the angle of the incident angle θ1 strikes the inspection object W. At this time, since the line sensor camera 25 is disposed at a position of the incident angle θ0′ with respect to the inspection object W, in the case of there being absolutely no irregularities in the inspection object W, a state of dark-field illumination arises, so that the light flux specularly reflected by the surface of the inspection object W does not form an image on the line sensor camera 25. However, in the case of there being scratches, dust or defects, or a regular pattern on the inspection object W, light flux that diffuses at a reflection angle θ0′ (=θ0) is generated among the light flux that is incident at the angle of the incident angle θ1, the line sensor camera 25 captures the image of this reflected light.

The line sensor camera 25 converts the image-formation light into an electrical signal and outputs it to the image capture circuit 31 for each line. The drive control portion 37 outputs an imaging start trigger signal to the image capture circuit 31 and causes scanning of the scan stage 10 to start in the uniaxial direction shown by the arrow A. Since the inspection object W thereby moves with respect to the line sensor camera 25, by piecing together the data output from the line sensor camera 25 in the order it is captured, an overall image of the inspection object W is obtained.

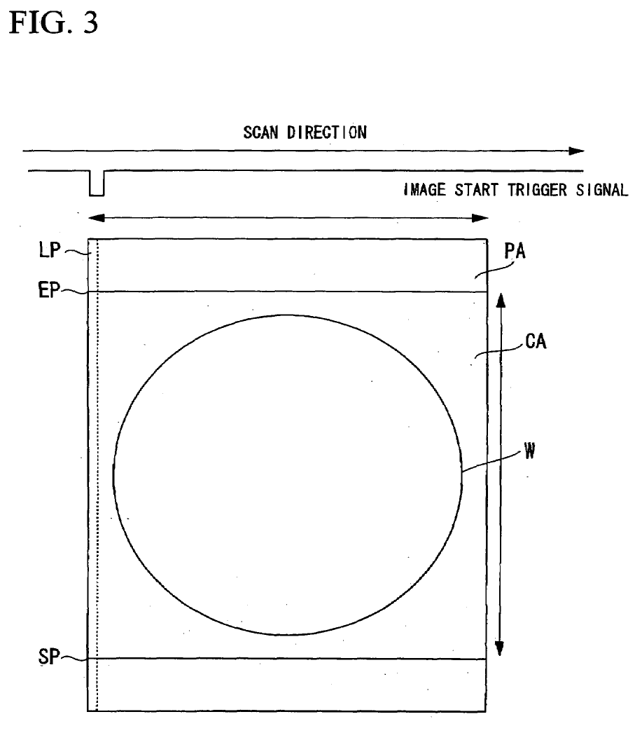

A concrete example of the process described so far is explained with reference to FIG. 3. In FIG. 3, the lateral direction shows the scanning direction of the scanning stage 10, i.e., passage of time. The lengthwise direction corresponds to the arrangement of pixels (light receiving surfaces) of the line sensor camera 25. By the imaging start trigger signal, the image capture circuit 31 starts receiving the electrical signals (image data) output from the line sensor camera 25. The image capture circuit 31 commences image capture from a capture start pixel position SP and completes the capture at the capture end pixel position EP in an image LP corresponding to one line, without capturing the electrical signals from both ends among the image LP. The capture start pixel position SP and the capture end pixel position EP are defined in advance in the drive control portion 37 and set so that the inspection object W fits within the range to be captured, with the regions in which the inspection object W does not enter being cut so as to reduce the data size of the image.

Furthermore, the number of lines (capture line number) to capture an image from the imaging start trigger signal is also defined by the drive control portion 37 in advance, with the image capture circuit 31 performing capture of an image only for the capture line number. As a result, a capture area CA is a square image formed by adding together the images from the capture start pixel position SP to the capture end pixel position EP only by the capture line number. The capture area CA is smaller than the image forming area in the line sensor camera 25 (imaging area PA).

Data corresponding to the image of the capture area CA that is thus obtained is corrected to the original image by applying shading compensation using shading data that is stored in advance in the compensating portion 32. Also, distortion compensation is performed using distortion data stored in advance to restore to the image to which the original magnification is applied. In addition, if necessary, after performing filtering or the like by the image preprocessing portion 33, the raw image data of the entire inspection object W (two-dimensional image data) is constructed and stored in the image storage portion 35.

Next, compression processing is performed on the raw image, and after reducing the size of the data, defects are extracted.

The image compression portion 34 compresses the raw image data by arithmetic computation with adjacent pixels from the raw image data to reduce the image size and thereby creates compressed image data. For example, by taking the average of a 5-by-5-pixel and compressing to one pixel, the image data size can be reduced to 1/25^{th} of the raw image. This compressed image data is stored in the image storage portion 35.

The compressed image data that is stored in the image storage portion 35 is sent to the defect extracting portion 41 of the image processing portion 4 to be compared with the image of an ideal non-defective inspection object that is stored in the image storage portion 35. Out of the outer shape image of the inspection object, which is a characteristic image of the inspection object W, the outer shape image of the exposure range and specific pattern images or the like are removed. Then, the points of difference of the image of the non-defective inspection object and the image are extracted by image processing. A predetermined region including a point of difference is treated as a region in which the defect extracting portion 41 has determined there to be a defect (defect area). The coordinate data of the defect area extracted by the defect extracting portion 41 is sent to the area designating portion 36.

Next, to be able to accurately inspect the defect in greater detail, the defect inspection apparatus 1 reacquires the image of the defect area to acquire only the image of the required region as an uncompressed image. Also, inspection may be enabled by changing the imaging conditions as required. For example, an instruction is issued to the illumination angle driving portion 23 as required to set conditions different from the conditions when the entire inspection object W is imaged so as to inspect in detail. Also, the imaging angle of the line sensor camera 25 may be changed. Here, the illumination portion 20 is set so as to illuminate at the angle of the incident angle θ0 (=θ0′) with respect to the inspection object W (solid line in FIG. 2). Then, the drive control portion 37 issues an instruction to the filter driving portion 27 to insert the narrow band filter 26 into the optical path. Thereby, if the inspection object W is a substrate such as a semiconductor wafer or the like and is coated with a thin film, such as a resist or the like, the detection of film unevenness becomes possible. The area designating portion 36 sets the timing to output the imaging start trigger signal to the drive control portion 37 based on the coordinate data of the defect area that is input from the defect extracting portion 41 and sets the capture line number, the capture start pixel position, the capture end pixel position to the image capture circuit 31. The drive control portion 37 of FIG. 1 outputs an instruction to the scan stage driving portion 11 to make the scan stage 10, on which the inspection object W is mounted, move in the uniaxial direction shown by the arrow A. From the drive control portion 37, the imaging start trigger signal is output to the image capture circuit 31 at the timing set by the area designating portion 36.

The line sensor camera 25 takes in the reflected light of the inspection object W that is illuminated by the illumination part 20 and converts the image forming light to an electrical signal. The electrical signal is output to the image capture circuit 31 line by line. At this time, the image capture circuit 31 does not perform image capture until the imaging start trigger signal generated by the drive control portion 37 is input. It performs capture of electrical signals only for the period from the line, at which the imaging start trigger signal is input, to the capture line number that is designated by the area designating portion 36. Also, for each capture line, only the electrical signals from the capture start pixel position to the capture end pixel position are captured.

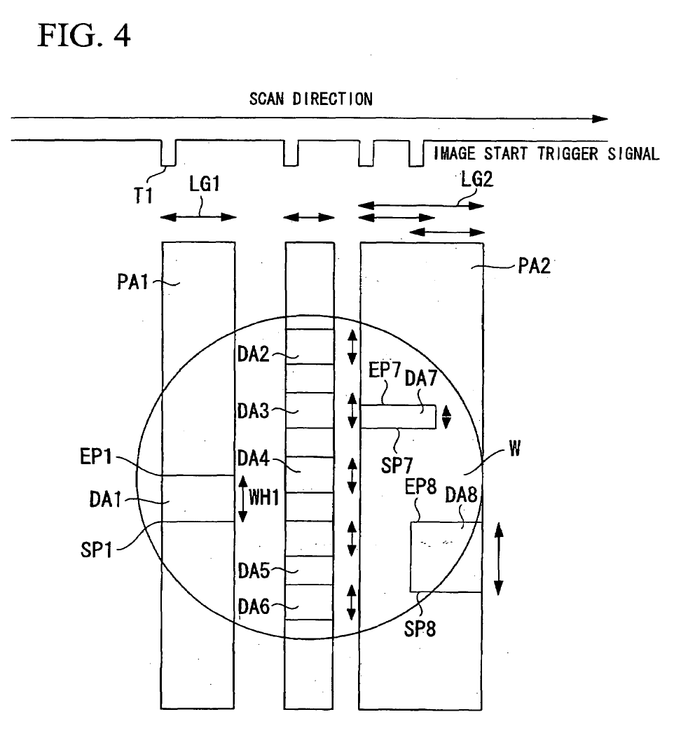

An illustrative example of the process up to this point will be described with reference to FIG. 4. In the case of the defect extracting portion 41 having extracted eight defect areas DA1 to DA8, the area designating portion 36 calculates and sets the imaging start trigger signal, capture line number, capture start pixel position, and capture end pixel position for each defect area DA1 to DA8. For the defect area DA1, an imaging start trigger signal T1, a capture line number corresponding to at image length LG1 in the scan direction, and a capture start pixel position SP1 and capture end pixel position EP1 corresponding to an image length WH1 in the length direction of the line sensor camera 25 are set. Although the line sensor camera 25 successively acquires an image including the inspection object W, the image capture circuit 31 accepts only the electrical signals in the range from the capture start pixel position SP1 to the capture end pixel position EP1 by the capture line number. As a result, only the defect area DA1 corresponding to the image length LG1 by image length WH1 is captured. The image size of the defect area DA1 is sufficiently smaller than the imaging area PA1 of the line sensor camera 25 which corresponds to the image length LG1.

Below, images are similarly captured for the other defect areas DA2 to DA8. The defect area DA7 and the defect area DA8 partially overlap in the scan direction. In this case, the image capture from the capture start pixel position SP8 to the capture end pixel position EP8 and the image capture from the capture start pixel position SP7 to the capture end pixel position EP7 are carried out in parallel in one line. The image size of the defect area DA7 and the defect area DA8 are sufficiently smaller than the imaging area PA2 of the line sensor camera 25 which corresponds to the image length LG2.

Shading compensation and distortion compensation are similarly performed by the compensation portion 32 on the data of only the defect areas thus designated. After performing filtering and the like with the image preprocessing portion 33 if required, the raw image data for each defect area are constructed and stored in the image storage portion 35. When doing so, the image compression portion 34 may compress the raw image data as required similarly to above and then store it in the image storage portion 35. The image storage portion 35 sends the raw image data, or raw image data that is imaged by altering the condition of the illumination angle as required, to the defect classification portion 42.

The defect classification portion 42 reads defect information stored in advance from the defect dictionary 44 for comparison based on detailed image data of the defect area and specifies the type of defect. The name of the defect that is registered in advance is given to the specified defect. From the content of the defect information that is created in this way, it is determined by the defect determination portion 43 whether or not the defect exists on the inspection object W and it is determined whether or not the inspection object W may be passed downstream in the production line. For example, in the case of a defect being in a position that does not impair the quality of the finished article or in the case of the size of the defect not impairing the quality of the finished article, it is determined that the inspection object may be passed downstream in the production line. In the case of the defect being determined to impair the quality of the finished article, an instruction is output to remove the inspection object W from the production line. In this case, the inspection object W is either automatically removed from the production line, or an operator who is notified removes the inspection object W from the production line.

Then, after the pass/rejection determination is performed by the defect determination portion 43, the raw image data of the defect area that is extracted by the defect extracting portion 41, the raw image data of the defect area that is imaged with altered imaging conditions, the defect information, the detonation result of the defect determination portion 43 or the like are stored in the image determination result storage portion 51 of the image storage portion 5.

According to the present embodiment, compressed image data are created from the entire image of the inspection object W, and defects are extracted using the compressed image data. Therefore, compared to the case of processing large-capacity raw image data, the inspection time can be shortened. After performing defect extraction with the compressed image data, uncompressed images are reacquired for the extracted areas to enable detailed inspection of the defect areas using uncompressed images. Since only the images of the defect areas are acquired, the time required for image processing and the like can be shortened. Moreover, when reacquiring only the extracted defect areas, since only the required information is fetched by processing of the control portion 3 instead of using a mechanical mask or the like on the line sensor camera 25 side, it is possible to simplify the structure of the apparatus and flexibly respond to changes and the like in the acquisition areas. Moreover, in the case of reacquiring by altering the imaging conditions, it is possible to perform an inspection at greater detail and accuracy.

A second embodiment of the present invention shall now be described in detail referring to the drawings.

This embodiment is mainly characterized by performing inspection of the periphery portion (wafer edge portion) of a wafer. That is, when production is continued with a crack occurred in a wafer, the wafer may split during production. Therefore, it is desired to determine whether a wafer is defective or non-defective by detecting the existence of cracks in the wafer edge portion at the earliest stage.

Also, in the photolithography step, after a thin film of a photoresist is applied on the surface of a wafer, by applying a suitable amount of a rinse agent, the photoresist at the periphery of the wafer is cut by a predetermined width to expose the wafer edge portion. This is done to prevent particles from being generated from the photoresist that is unnecessarily spread over to the back surface and leads to defects.

The present embodiment was achieved focusing on the inspection of the wafer edge portion at this stage becoming an essential inspection item in terms of manufacturing a non-defective semiconductor wafer by carrying out processes in subsequent steps. Note that since the constitution of the apparatus is identical to that in the first embodiment, overlapping descriptions will be omitted.

In measuring the edge cut line width of the inspection object W that is a wafer, it is possible to assume a distribution of the wafer edge portion just for example by measuring the edge cut line width of the inspection object W at a total of four locations shifted by 90° with each other in the circumferential direction, without measuring all of the areas of the wafer edge portions. The description below begins from the present apparatus commencing operation by the inspection start being input to the operation input portion 29.

First, the measurement areas are set from the operation input portion 29 to the area designating portion 36 of FIG. 1. The areas to be set are areas corresponding to the wafer edge portion at 90° intervals as described above.

The area designating portion 36 sets the pulse number that outputs the rotating stage imaging start trigger signal to the drive control portion 37 based on the set areas and sets the capture line number, the capture start pixel position, and the capture end pixel position to the image capture circuit 31. Once the inspection start signal is input from the operation input portion 29, after positioning the inspection object W similarly to the previous embodiment, the drive control portion 37 of FIG. 1 outputs an instruction to the scan stage driving portion 11 to make the scan stage 10, on which the inspection object W is mounted, move to a position in which the imaging line of the line sensor camera 25 and the center of the inspection object W overlap.

Next, the drive control portion 37 outputs an instruction to the rotating stage driving portion 13 to rotate the rotating stage 12 on which the inspection object W is mounted 180°. At this time, an imaging start trigger signal is output from the drive control portion 37 to the image capture circuit 31 at a timing set by the area designating portion 36.

At this time, the image capture circuit 31 receives the imaging start trigger signal that is output from the drive control portion 37 and, from the line at which the signal was received, captures only the electrical signals from the designated capture start pixel position to the designated capture end pixel position among the capture line number designated by the area designating portion 36.

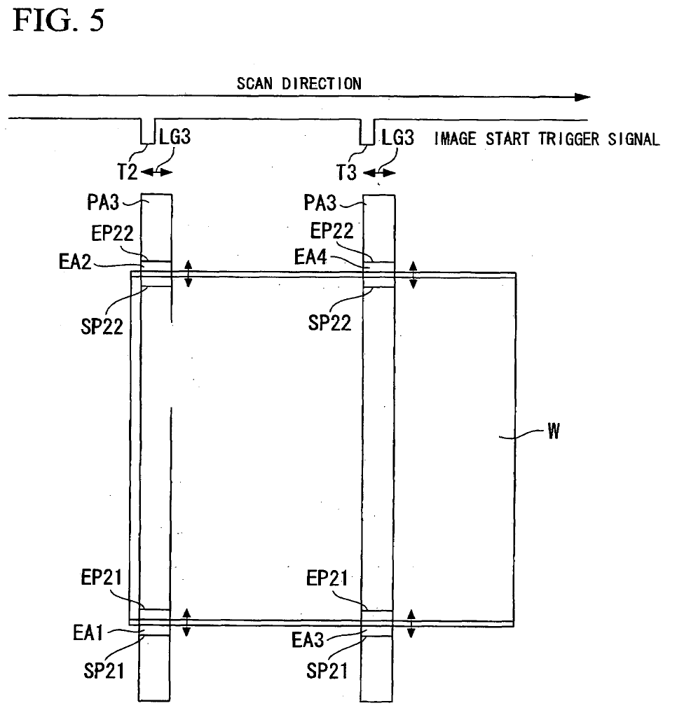

A specific example of the process up to this point will be described with reference to FIG. 5. In FIG. 5, the scan direction shows the amount of rotation of the rotating stage 12. Since the line sensor camera 25 does not move with respect to the rotation of the rotating stage 12, the image of the inspection object W becomes square and the wafer edges appears at both ends along the scan direction. On the inner side of the wafer edges, the resist is removed and an edge cut line appears in which the surface of the wafer, which is the inspection object W, is exposed. From an imaging start trigger signal T2, the image capture circuit 31, captures from the capture start pixel position SP21 to the capture end pixel position EP21, and from the capture start pixel position SP22 to the capture end pixel position EP22, and ends the capture by a capture line number corresponding to an image length LG3. The inspection areas EA1 and EA2 are sufficiently smaller than the imaging area PA3 of the line sensor camera 25 which corresponds to the image length LG3.

Moreover, since an imaging start trigger signal T3 is output at a timing corresponding to the position in which the rotating stage 12 is rotated by 90°, the image capture circuit 31 captures an image of inspection area EA3 by pixel positions SP21 and EP21 and an image of inspection area EA4 by pixel positions SP22 and EP22 as described above. The inspection areas EA3 and EA4 correspond to the images of positions rotated 90° about the center of the inspection object W with respect to the inspection areas EA1 and EA2. The image sizes of the inspection areas EA3 and EA4 are sufficiently smaller than the imaging area PA3 of the line sensor camera 25 which corresponds to the image length LG3.

Shading compensation and distortion compensation are similarly performed by the compensation portion 32 with respect to the data composed of only the designated defect areas. After performing filtering and the like with the image preprocessing portion 33 if required, the raw image data of the entire inspection object W are constructed and stored in the image storage portion 35.

Also, at this time, the raw image data is compressed by arithmetic computation of the raw image data with adjacent pixels by the image compression portion 34 similarly to above, and this compressed image data is stored in the image storage portion 35.

The image storage portion 35 sends the compressed image data or raw image data to the defect extracting portion 41. In the defect extracting portion 41, it is compared with an image of an ideal non-defective article that is stored in the image storage portion 35, the width of the edge cut line of the wafer is measured, and only defect areas in which cracks or foreign materials occur are extracted. The defect area data extracted by the defect extracting portion 41 are sent to the defect classification portion 42. In the defect classification portion 42, based on the image data of that defect area, a comparison is made with defect information stored in advance that is read from the defect dictionary 44 to determine the defect type. When a defect that is registered in the defect dictionary 44 is found, the name of that defect is applied to the defect area that is extracted.

Moreover, in the defect determination portion 43, it is determined from the content of the defect information whether or not a defect exists on the inspection object W and whether or not the inspection object W may be passed downstream in the production line. After the pass/rejection determination by the defect determination portion 43, the raw image data of the defect area that is extracted by the defect extracting portion 41, the defect information, the determination result or the like are stored in the image determination result storage portion 51 of the image storage portion 5. Note that when a defect was not extracted by the defect extracting portion 41, the inspection object may be determined to be non-defective as it is by the defect determination portion 43.

Here, according to need, the image of the defect area that is extracted by the defect extracting portion 41 may be reacquired with altered imaging conditions in order to enable accurate inspection of the defect in detail, similarly to the first embodiment. Thereby, detailed inspection of the defect can be performed.

According to this embodiment, when an area to be inspected is decided in advance, by setting the inspection area and starting the inspection, it is possible to efficiently perform inspections with small-capacity image data of only the areas required for inspection. Therefore, by quickly performing an inspection of the edge cut line, it is possible to detect cracks or the like in the inspection object W in early stage.

The present embodiment is not limited to the inspection of the edge cut line. It may also be applied to the case of inspections of a plurality of inspection points set by an operator, as in the case of spiral measurement. Even in this case, it is possible to quickly perform the inspection.

A third embodiment of the present invention will now be described in detail referring to the drawings.

When performing an inspection using only a compressed image, it is possible to inspect large defects, but not possible to make a proper determination depending on the type and size of a defect. This embodiment was achieved for solving this problem. Moreover, by automatically performing classification of the type of defect or the like, the inspection efficiency can be improved. Note that since the constitution of the apparatus is identical to that in the first embodiment as shown in FIG. 1 and FIG. 2, the action will be described hereinbelow while omitting descriptions of the constitution.

The conveying device takes out a specified inspection object W from the carrier and accurately places it on a table 14 with its decentration corrected. When the inspection object W is accurately placed on the table 14, the drive control portion 37 of FIG. 1 turns the attraction solenoid valve 150N to attract and fix the inspection object W on the table 14. Then, the drive control portion 37 issues an instruction to the scan stage driving portion 11 to move the scan stage 10 and move the periphery portion of the inspection object W to within the measurement range of a notch detection sensor which is included in the various sensors 28. Moreover, the drive control portion 37 issues an instruction to the rotating stage driving portion 13 to rotate the rotating stage 12. When the notch detection sensor detects a notch on the periphery portion of the inspection object W, that position is registered as a reference. Thereafter, the rotating stage 12 is rotated so that the rotation position of the inspection object W may always be the same.

After determining the rotation position of the notch detection sensor and the rotating stage 12, the drive control portion 37 issues an instruction to the scan stage driving portion 11 to uniaxially move the scan stage 12 on which the inspection object W is mounted. When the inspection object W moves uniaxially, it is illuminated at the angle of the incident angle θ0 by the illumination portion 20 and light that is converged by the cylindrical lens 21 of FIG. 2.

Of light flux that is reflected from the linear portion of the inspection object W that is illuminated, only a specific wavelength of the light rays forms an image on the line sensor camera 25 due to the narrow band filter 26 that is inserted in the optical system. At this time, when there is a change in the film thickness on the surface of the inspection object W, interference occurs among the wavelengths passing through the narrow band filter 26, so that changes in the film thickness can be detected as changes in the light volume.

The line sensor camera 25 converts the image-formation light into an electrical signal and outputs it to the image capture circuit 31 for each line. The image capture circuit 31 converts the electrical signal of each line into data in accordance with the movement of the inspection object W, similarly to the illustrated example shown in FIG. 3. Moreover, shading compensation and distortion compensation are performed by the compensation portion 32 on the data that is captured by the image capture circuit 31. Furthermore, the raw image data of the entire inspection object W is constructed and stored in the image storage portion 35 after performing filtering or the like by the image preprocessing portion 33 if necessary. Also, at this time, the raw image data is compressed by arithmetic computation with adjacent pixels by the image compression portion 34, and this compressed image data is stored in the image storage portion 35.

Here, the image storage portion 35 stores a plurality of images of inspection objects W that are considered ideal non-defective. The compressed image data that is stored in the image storage portion 35 is sent to the defect extracting portion 41 of the image processing portion 4 to be compared with images of ideal non-defective inspection objects W that are stored in the image storage portion 35. The outer shape image of the inspection object, which is a characteristic image of the inspection object W, the outer shape image of the exposure range, and specific pattern images are removed. Then, the points of difference of the image of the non-defective inspection object and the image are extracted by image processing. A predetermined region including a point of difference is treated as a region in which the defect extracting portion 41 has determined there to be a defect (defect area). The coordinate data of the defect area extracted by the defect extracting portion 41 is sent to the area designating portion 36.

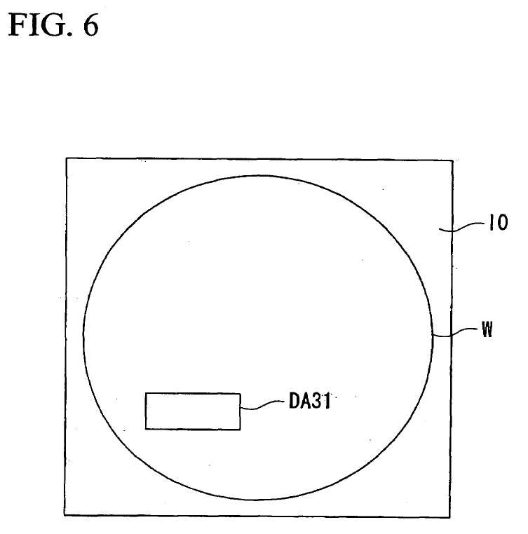

The image storage portion 35, based on the coordinate data that is sent to the area designating portion 36, cuts out only the defect area portion from the raw image data and sends the detailed image data, which is created by cutting out the defect area, to the defect classification portion 42. For example, as shown in FIG. 6, in the case of a defect area DA31 that is defined by coordinate data existing in a raw image I0, the image data that corresponds to the defect area DA31 is fetched as the detailed image data.

The defect classification portion 42 reads defect information stored in advance from the defect dictionary 44 for comparison based on the detailed image data of the defect area, specifies the type of defect, and applies a registered name to the specified defect.

A defect determination portion 43 regards the inspection object W as being non-defective when a defect is not extracted by the defect extracting portion 41. When a defect is extracted by the defect extracting portion 41, the defect classification portion 42 specifies the classification and type of the defect while referring to the defect dictionary 44, and the defect determination portion 43 judges whether or not the defect exists on the inspection object W from the content of the defect information. Moreover, it determines whether or not the inspection object W may be passed downstream in the production line. Similarly to above, the raw image data of the defect area, the defect information, and the determination result or the like are stored in the image determination result storage portion 51. Thereafter, by operation from the operation input portion 29, the stored defect area image data and the determination result can be referred to anytime.

According to the present embodiment, extracting defects using appropriate compressed data can save the time required for transferring or the like large-capacity raw image data. In case of extracting defects, it is not necessary to take time in processing using large-capacity raw image data. Following the extraction of a defect using small-capacity compressed data, detailed classification of defects or determination of defective or non-defective on defects are performed by fetching the raw image data only for the extracted defect areas, defect inspection can be efficiently carried out. By using the defect classification portion 42 and the defect dictionary 44, defect inspection can be performed while making a comparison with defects registered in advance, it becomes easy to confirm defects with a high frequency of occurrence and defects that tend to occur at the same place.

The present invention is not limited to the embodiments described above, and can be broadly applied.

For example, the image data that is used after designating a defect area does not necessarily need to be raw image data, and according to need, may be compressed image data to which compression has been applied. When inspecting only defects that are comparatively large, it is possible to shorten the processing time.

A constitution was adopted that enables imaging of the entire inspection object W using the line sensor camera 25, but such a constitution that images the inspection object W in multiple passes in order to further raise the resolution may also be possible.

The first embodiment disclosed a method of reacquiring image data of only defect areas by changing the angle of the illumination portion 20 with respect to a defect area that is detected by the compressed image data, but is not restricted thereto, and may be an apparatus employing another method of observation. For example, it may reacquire the defect area image by different observation methods such as bright field observation, dark field observation, diffracted light observation, and back surface observation or the like. Also, if an apparatus has other optical conditions, the defect area image may be reacquired by different optical conditions such as changing the type of filter, inserting/removing a polarizing plate, or changing the illumination light or the like.

Also, by altering the settings of parameters (imaging start trigger signal timing, capture line number, capture start pixel position, capture end pixel position), it is possible to efficiently carry out inspection even for inspection objects of different sizes, such as small wafers and the like.

This defect inspection apparatus uses compressed image data in the stage of extracting defects. In the case of the existence of a defect being recognized in the compressed image data, the image of the area in which the existence of the defect is recognized is obtained from the raw image that is not compressed. Moreover, a detailed inspection is carried out by, for example, comparing the extracted raw image and defect information that is registered in advance. According to the invention, by extracting defects effectively using compressed image data, and comparing the raw image and defect information that is registered in advance with regard to the area where defects are extracted, it is possible to double check defects and to perform detailed inspection.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A defect inspection apparatus comprising:
an imaging device that captures image data as optical image information of an inspection object;
an image compression portion that treats the image data captured by the imaging device as a raw image and compresses the raw image to generate compressed image data;
a defect extracting portion that extracts a defect area including a defect of the inspection object from the compressed image data; and
an area designating portion that designates the defect area extracted by the defect extracting portion;
which performs defect inspection on the raw image data of the area that is designated and acquired by the area designating portion.

2. The defect inspection apparatus according to claim 1, further comprising:
a holding portion that holds an inspection object in a freely movable manner; and
an image capture portion that captures image data that is output from the imaging device to create an image relating to the inspection object,
wherein the imaging device comprises a line sensor in which a plurality of imaging elements are linearly disposed;
the area designating portion sets the imaging elements that capture image data from the plurality of imaging elements of the imaging device and sets the number of times to capture the image data by the imaging elements in synchronization with the movement of the holding portion; and
the image capture portion captures the image of the area that is set by the area designating portion from the output of the imaging elements.

3. The defect inspection apparatus according to claim 1, wherein the imaging device is arranged to change the imaging conditions to acquire the entire image for generating the compressed image data and the imaging conditions in the case of an area being designated.

4. The defect inspection apparatus according to claim 2, wherein the image capture portion is arranged to acquire the entire image of the inspection object when an area is not designated.

5. The defect inspection apparatus according to claim 2, wherein the holding portion has a rotating stage that rotates the inspection object of a circular shape, and the area designating portion is arranged to acquire an image of the outer edge portion of the inspection object.

6. The defect inspection apparatus according to claim 1, further comprising an image storage portion that stores at least one of the raw image data or the compressed image data.

7. The defect inspection apparatus according to claim 6, further comprising:
a defect classification portion that classifies a defect included in a defect area that is obtained from the raw image data and specifies the type of defect;
a defect dictionary in which defect information is stored in advance; and
a defect determination portion that compares defect information that is classified by the defect classification portion and defect information that is included in the defect dictionary and determines whether or not the inspection object is non-defective or defective.

8. The defect inspection apparatus according to claim 7, further comprising an image determination result storage portion that stores in a referable manner the determination result of the defect determination portion and the image of a defect area that is used for the determination.

9. The defect inspection apparatus according to claim 1, further comprising an image storage portion that stores the raw image data, wherein uncompressed image data of a defect area is acquired by being removed from the raw image data that is stored in the image storage portion.

10. The defect inspection apparatus according to claim 2, wherein the imaging device is arranged to change the imaging conditions to acquire the entire image for generating the compressed image data and the imaging conditions in the case of an area being designated.
